(19) United States
(12) Patent Application Publication
(10) Pub. No.: US 2007/0081357 A1
(43) Pub. Date: Apr. 12, 2007

(54) Display apparatus and method of controlling the same

(75) Inventors: Sung-soo Kim, Suwon-si (KR); Yung-jun Park, Yongin-si (KR); Jun-ho Sung, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/540,598

(22) Filed: Oct. 2, 2006

(30) Foreign Application Priority Data
Oct. 12, 2005 (KR) 2005-0095789

(51) Int. Cl. F21V 7/04

(52) U.S. Cl. 362/561

(57) ABSTRACT

A display apparatus having a liquid crystal panel, comprises a light source part comprising a plurality of point light sources for supplying light to the liquid crystal panel. The light source part is partitioned into a plurality of light source zones. A light source driving part supplies power to the light source part. A plurality of channel parts sense luminescence of the point light sources for each of the light source zones and output light-emission information of the point light sources based on the sensed luminescence. A controller compares the light-emission information output from the plurality of channel parts with a pre-set reference value. If a difference between the light-emission information and the reference value is out of a predetermined allowable range, the controller sequentially adjusts PWM control signals which are output to the light source driving part, for each of the light source zones.

### CROSS-REFERENCE TO RELATED APPLICATIONS

This application claims the benefit under 35 U.S.C. §119(a) of Korean Patent Application No. 2005-0095789, filed on Oct. 2, 2005, the entire disclosure of which is hereby incorporated by reference.

### BACKGROUND OF THE INVENTION

1. Field of the Invention

The present invention relates to a display apparatus and a control method of the same. More particularly, the present invention relates to a display apparatus having a plurality of light-emitting elements as a light source, and a method of controlling the same.

2. Description of the Related Art

Display apparatuses are increasingly employing LEDs (Light-Emitting Diodes) rather than conventional CCFLs (Cold Cathode Fluorescent Diodes) as point light sources in order to improve the reproduction of colors.

Recently, as display apparatuses become larger in size, there is an increasing need to dispose a plurality of light sources in a plurality of regions within the display apparatus, respectively, and control the light sources for each region. The display apparatuses must have a plurality of sensors corresponding to the plurality of regions in order to control luminance or color temperature of light emitted from the light sources. Currently, an IC for processing information on luminance of light emitted from the light sources can process only information sensed by a single channel, that is, a single RGB light-emitting diode unit.

Accordingly, it is currently necessary to provide a plurality of ICs for processing light emission-related information sensed by the plurality of sensors, which results in an undesirable increase of production costs.

### SUMMARY OF THE INVENTION

Accordingly, it is an aspect of the present invention to provide a display apparatus for easily processing light emission-related information sensed for each optical zone, and a control method thereof.

It is another aspect of the present invention to provide a display apparatus with reduced production costs, and a control method thereof.

The foregoing and/or aspects of the present invention can be achieved by providing a display apparatus having a liquid crystal panel, comprising a light source part comprising a plurality of point light sources for supplying light to the liquid crystal panel, the light source part being partitioned into a plurality of light source zones; a light source driving part for supplying power to the light source part; a plurality of channel parts for sensing luminescence of the point light sources for each of the light source zones and outputting light-emission information of the point light sources based on the sensed luminescence; and a controller for comparing the light-emission information output from the plurality of channel parts with a pre-set reference value, and, if a difference between the light-emission information and the reference value is out of a predetermined allowable range, sequentially adjusting PWM control signals, which are output to the light source driving part, for each of the light source zones.

According to an aspect of the invention, the light-emission information is white color coordinates of the point light-emitting sources.

According to an aspect of the invention, each of the plurality of channel parts comprises a sensor for sensing luminescence of light emitted from the point light sources; and a color coordinate calculator for calculating the white color coordinates of the point light sources based on the luminescence sensed by the sensor.

According to an aspect of the invention, the display apparatus further comprises a PWM delay part for delaying the PWM control signals output from the controller according to a predetermined synchronization signal.

According to an aspect of the invention, the reference value is a color temperature value and/or a particular region on a gray axis.

The foregoing aspects of the present invention can be achieved by providing a control method of a display apparatus comprising a liquid crystal panel, and a light source part comprising a plurality of point light sources for supplying light to the liquid crystal panel. The light source part is partitioned into a plurality of light source zones. The method comprises sensing luminescence of the point light sources for each of the light source zones; outputting light-emission information of the light source zones based on the sensed luminescence; comparing the output light-emission information with a pre-set reference value and sequentially adjusting PWM control signals, which are output to the light source part, for each of the light source zones; and delaying the PWM control signals according to a predetermined synchronization signal.

The light-emission information is preferably white color coordinates of the point light-emitting sources. The method preferably comprises calculating the white color coordinates of the point light sources based on the sensed luminescence. The reference value is preferably a color temperature and/or a particular region on a gray axis.

The foregoing aspect of the present invention can be achieved by providing a computer readable medium of instructions for controlling a display apparatus comprising a liquid crystal panel and a light source part comprising a plurality of point light sources for supplying light to the liquid crystal panel The light source part is partitioned into a plurality of light source zones. The instructions include a first set of instructions adapted to control the apparatus to sense luminescence of the point light sources for each of the light source zones. A second set of instructions controls the apparatus to output light-emission information of the light source zones based on the sensed luminescence. A third set of instructions compares the output light-emission information with a pre-set reference value and sequentially adjusts PWM control signals if the difference between the output and the pre-set reference value is out of a predetermined rance. Finally, a fourth set of instructions delays the PWM control signals according to a predetermines synchronization signal.

The foregoing aspects of the present invention can be achieved by providing a display apparatus having a liquid crystal panel. The apparatus includes a light source part comprising a plurality of point light sources for supplying light to the liquid crystal panel. The light source part is partitioned into a plurality of light source zones. There is a light source driving part for supplying power to the light source part. A controller sequentially adjusts PWM control signals, which control signals are output to the light source driving part, for each of the light source zones.

The display apparatus preferably includes a plurality of channel parts for sensing luminescence of the point light sources for each of the light source zones and outputting light-emission information of the point light sources based on the sensed luminescence. The controller preferably compares the light-emission information output from the plurality of channel parts with a pre-set reference value, and adjusts PWM control signals if a difference between the light-emission information and the reference value is out of a predetermined range. Each of the plurality of channel parts preferably comprises a sensor for sensing luminescence of light emitted from the point light sources, and a color coordinate calculator for calculating the white color coordinates of the point light sources based on the luminescence sensed by the sensor. The apparatus preferably includes a PWM delay part for delaying the PWM control signals output from the controller according to a predetermined synchronization signal.

### BRIEF DESCRIPTION OF THE DRAWINGS

The above and/or other aspects and advantages of exemplary embodiments of the present invention will become apparent and more readily appreciated from the following description, taken in conjunction with the accompanying drawings of which:

FIG. 1 is a control block diagram of a display apparatus according to an exemplary embodiment of the present invention;

FIGS. 2A and 2B are waveform diagrams illustrating delay of PWM control signals according to an exemplary embodiment of the present invention;

FIGS. 3A to 3D are views illustrating an image of a liquid crystal panel according to the PWM delay shown in FIG. 2; and

FIG. 4 is a control flow chart illustrating a control method of the display apparatus according to an exemplary embodiment of the present invention.

Throughout the drawings, like reference numbers should be understood to refer to like elements, features and structures.

### DETAILED DESCRIPTION OF EXEMPLARY EMBODIMENTS

Reference will now be made in detail to exemplary embodiments of the present invention, examples of which are illustrated in the accompanying drawings.

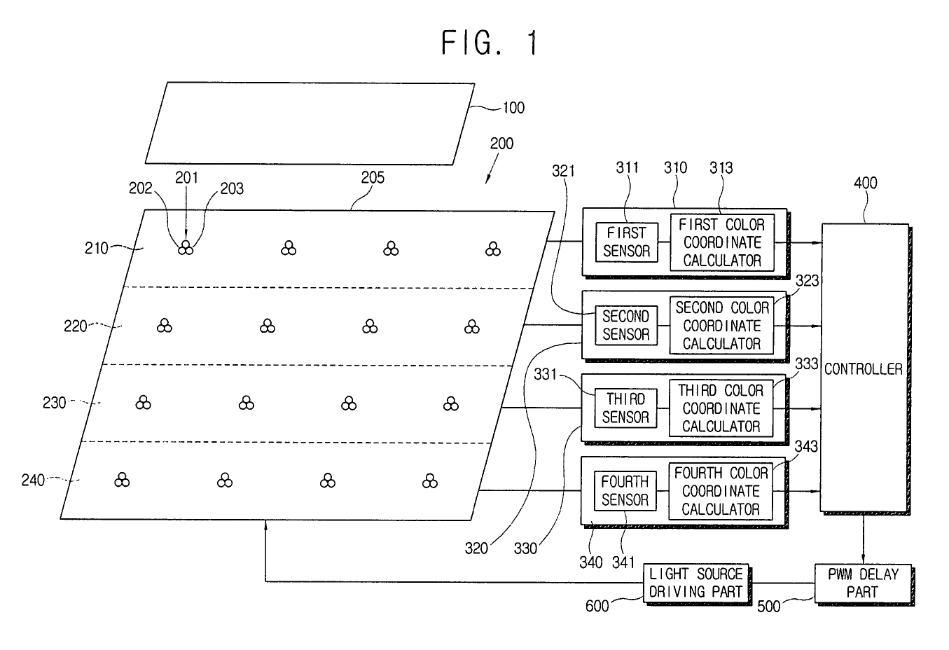

FIG. 1 is a control block diagram of a display apparatus according to an exemplary embodiment of the present invention. As shown in FIG. 1, a display apparatus includes a liquid crystal panel 100, a light source part 200, a channel part 300, a controller 400, a PWM delay part 500, and a light source driving part 600.

Although not shown in the figure, the liquid crystal panel 100 preferably includes a thin film transistor substrate with a plurality of transistors formed thereon, a color filter substrate facing the thin film transistor substrate, a sealant bonding both substrates together and forming a cell gap, and a liquid crystal layer placed between both substrates and the sealant. In this embodiment, the liquid crystal panel 100 has a rectangular form with long sides and short sides.

The liquid crystal panel 100 forms an image by adjusting arrangement of the liquid crystal layer. However, since the liquid crystal panel 100 is a non-light emitting device, it has to receive light from the light source part 200 located at a rear side of the liquid crystal panel 100. The display apparatus may further include a light adjusting member for increasing efficiency of light emitted from the light source part 200 and adjusting the amount of light between the liquid crystal panel 100 and the light source part 200.

The light source part 200 includes a plurality of light-emitting diodes 201, 202 and 203 as point light sources, and a light-emitting diode substrate 205 on which the light-emitting diodes 201, 202 and 203 are mounted. The light-emitting substrate 205 is located over the entire rear side of the liquid crystal panel 100 and is partitioned into a plurality of light source zones 210, 220, 230 and 240, each of which includes a plurality of light-emitting diodes 201, 202 and 203. In the following description, the light source zones 210, 220, 230 and 240 refer to the partitioned light-emitting diode substrate 205 including the light-emitting diodes 201, 202 and 203.

In this embodiment, the light source part 200 is generally divided into four light source zones 210, 220, 230 and 240, each of which includes a plurality of light-emitting diode units, each of which consists of RGB light-emitting diodes 201, 202 and 203. Each of the light-emitting diode units includes light-emitting diodes 201, 202 and 203 emitting red, blue and green light, respectively. A mixture of red, blue and green light is supplied as white light to the liquid crystal panel 100. It should of course be understood that this arrangement is merely exemplary and the arrangement method of the light-emitting diodes 201, 202 and 203 is not limited to the above-mentioned arrangement. In addition, the light source part 200 may include white light-emitting diodes other than the red, blue and green light-emitting diodes 201, 202 and 203, or may include light-emitting diode units emitting cyan, magenta and yellow light, for example. Further, the light source part 200 may be divided into more than four light source zones.

The channel part 310, 320, 330 and 340 includes first to fourth sensors 311, 321, 331 and 341 for sensing luminescence of the light-emitting diodes 201, 202 and 203, and first to fourth color coordinate calculators 313, 323, 333 and 343 for calculating white color coordinates of the light-emitting diodes 201, 202 and 203 based on the luminescence sensed by the sensors 311, 321, 331 and 341 for each of the light source zones 210, 220, 230 and 240. That is, the channel parts 310, 320, 330 and 340 output light-emission information indicating a light-emission state of the light-emitting diodes 201, 202 and 203 for each of the light source zones 210, 220, 230 and 240. In this embodiment, the light-emission information corresponds to the white color coordinates.

As a display apparatus becomes large, it is necessary to adjust the luminescence of light supplied to the liquid crystal panel 100 or the ON/OFF duty cycle of the light sources differently in even a single display apparatus. Accordingly, the display apparatus includes the plurality of sensors 311, 321, 331 and 341 and adjusts an overall optical characteristic of the light source part 200 according to the light-emission information output for each of the light source zones 210, 220, 230 and 240.

The sensors 311, 321, 331 and 341 sense luminescence of light emitted from the light-emitting diodes 201, 202 and 203. That is, in this embodiment, since the light-emitting diodes 201, 202 and 203 emit light of three RGB colors, each of the sensors 311, 321, 331 and 341 includes at least three sensing elements. Each of the sensing elements is constituted by a circuit element including a light-receiving diode or a photodiode and has a mechanism in which received light is converted into an electrical signal such as current.

The color coordinate calculators 313, 323, 333 and 343 calculate the white color coordinates for each of the light source zones 210, 220, 230 and 240 based on the luminescence of the light emitted from the light-emitting diodes 201, 202 and 203 and sensed by the sensors 311, 321, 331 and 341, and output the calculated white color coordinates to the controller 400. In general, the light luminescence is represented by a two-dimensional coordinate (x, y) of a CIE chromaticity diagram. An ideal value of the white color coordinate is generally (0.33, 0.33) although it may be varied depending on a value set by a user or color temperature. However, when the display apparatus is used for a long time, the color temperature of the display apparatus is mostly decreased due to deterioration of the liquid crystal layer and thin film transistors, and accordingly, the white color coordinate is also changed. The color coordinate calculators 313, 323, 333 and 343 calculate the changed color coordinate and output the calculated color coordinate to the controller 400.

The color coordinate calculators 313, 323, 333 and 343 may be digital image processors, and the calculation of the white color coordinate may be performed by various known algorithms.

The controller 400 compares the white color coordinate output from the plurality of channel parts 310, 320, 330 and 340 with a pre-set reference value, and, if a difference between the white color coordinate and the reference value is out of a predetermined allowable range, sequentially adjusts a PWM control signal output from the light source driving part 600. That is, the controller 400 sequentially processes information input in parallel from the channel parts 310, 320, 330 and 340 at time intervals and then outputs a changed PWM control signal to the PWM delay part 500 in series. Since the light-emitting diodes 201, 202 and 203 are to be switched on/off in correspondence to an image signal applied to the liquid crystal panel 100, the controller 400 also outputs a predetermined synchronization signal including a start signal such that the PWM control signal is output in synchronization with the image signal.

In general, a data processing speed of the channel part 310, 320, 330 and 340 is lower than that of the controller 400. Accordingly, in the display apparatus according to this embodiment, a single controller 400 may process various kinds of data, without having a plurality of controllers 400 in correspondence to a plurality of channel parts 310, 320, 330 and 340. To the end, the controller 400 may further include a phased lock loop (PLL) for multiplying a frequency of an input signal.

The controller 400 compares the white color coordinate output from the plurality of channel parts 310, 320, 330 and 340 with a color coordinate corresponding to predetermined color temperature and determines whether or not a difference between the white color coordinate and the color coordinate is out of a predetermined allowable range. If the difference is out of the predetermined allowable range, the controller 400 controls the PWM control signal to be output to the light source driving part 600 such that the color temperature of light supplied to the liquid crystal panel 100 is maintained at a constant value.

A reference value corresponding to the sensed light-emission information is the color temperature in this embodiment. However, the color temperature is provided only as an example. Various values representing optical characteristics may be the reference value. By way of a non-limiting example, a particular zone on a gray axis representing a gray scale may be set as the reference value.

The PWM delay part 500 delays PWM control signals output from the controller 400 according to the predetermined synchronization signal. Since the controller 400 outputs the PWM control signals in the order in which the PWM control signals are processed, the PWM control signals corresponding to the light source zones 210, 220 230 and 240 are input in series to the PWM delay part 500. However, the PWM delay part 500 may be output at predetermined time intervals or in parallel at once through the PWM delay part 500.

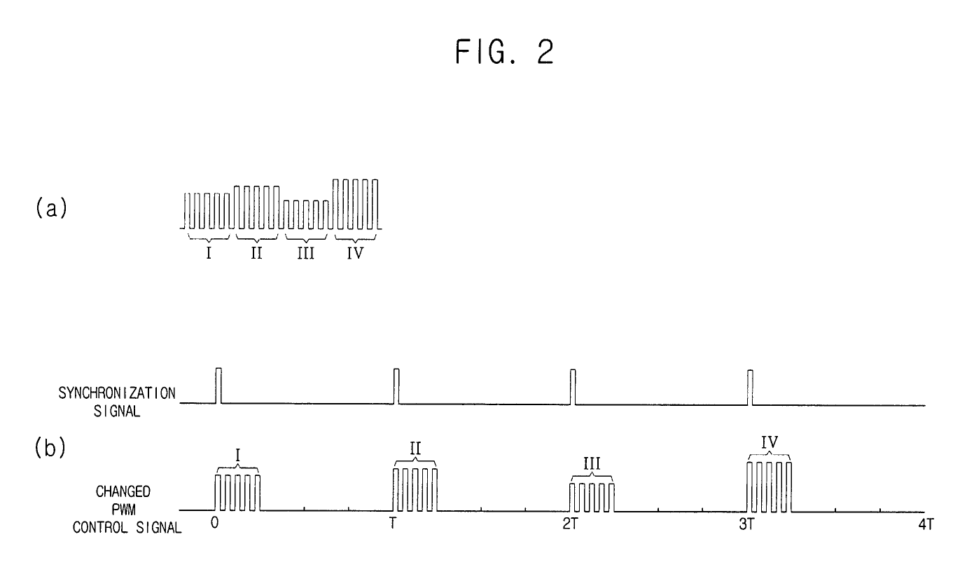

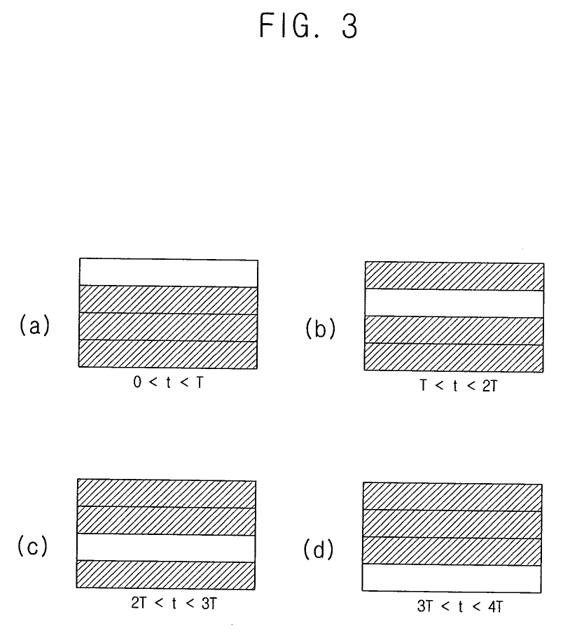

Hereinafter, the delay of the PWM control signals according to this embodiment will be described with reference to FIGS. 2A, 2B and 3A to 3D. FIGS. 2A and 2B are waveform diagrams illustrating delay of PWM control signals output from the controller 400 and PWM control signals output from the PWM delay part 500, respectively, and FIG. 3 is a view illustrating an image of the liquid crystal panel according to the PWM delay shown in FIG. 2.

As shown in FIG. 2A, the controller 400 outputs changed PWM control signals successively. I to IV regions represent PWM control signals changed for white color coordinates of first to fourth source zones 210 to 240. The PWM control signals input in series are output to the light source driving part 600 at predetermined intervals according to the synchronization signal shown in FIG. 2B.

In case of a display apparatus with the liquid crystal panel 100, since arrangement of liquid crystal is not quickly made for variation of a voltage of a stepped shape, not a linear shape, a motion blur effect occurs in the liquid crystal panel 100. In this embodiment, in order to reduce the motion blur effect, the display apparatus partitions the liquid crystal panel 100 into four zones and applies a black signal to three of the four zones.

In such a liquid crystal panel 100, four sub-frames must be formed in order to form an image corresponding to an existing frame, as shown in FIGS. 3A to 3D. Assuming that time taken to form one sub-frame, for which an image is formed in a portion of the liquid crystal panel 100 receiving light from each light source zone 210, 220, 230 and 240 and a black signal is applied to the remaining portions of the liquid crystal panel 100, is T, it takes 4T to form one complete frame.

An image signal to form each sub-frame is applied to the liquid crystal panel 100 at a period of T. In synchronization with the image signal, the PWM delay part 500 outputs a PWM control signal (I region) corresponding to the first light source zone 210 at zero second, a PWM control signal (II region) corresponding to the second light source zone 220 at T, a PWM control signal (III region) corresponding to the third light source zone 230 at 2T, and a PWM control signal (IV region) corresponding to the fourth light source zone 240 at 3T.

In brief, the PWM delay part 500 delays the PWM control signals, which are sequentially input in correspondence to the plurality of light source zones 210, 220, 230 and 240, in accord with the image signal applied to the liquid crystal panel 100, and then outputs the delayed PWM control signals to the light source driving part 600.

The PWM delay part 500 may be prepared as one chip, together with controller 400, or may be formed together with the controller 400. The above-described components are functionally separated from each other, but as will be appreciated by one of ordinary skill in the art, they need not be physically separated from each other.

As an alternative embodiment, the light source zones may be partitioned in a vertical direction. In this case, the changed PWM control signals corresponding to the light source zones must be output in parallel with no time difference. Since the image signal applied to the liquid crystal panel 100 is output from an upper portion to a lower portion of the liquid crystal panel 100, the light-emitting diodes must be turned on when the image signal is applied to the liquid crystal panel 100. Accordingly, the sequentially input PWM control signals are re-ordered and output in parallel simultaneously.

The light source driving part 600 includes a plurality of switching elements to be switched on/off by the input PWM control signal. Power is supplied from the outside to the light source part 200 by switching-on/off of the switching elements.

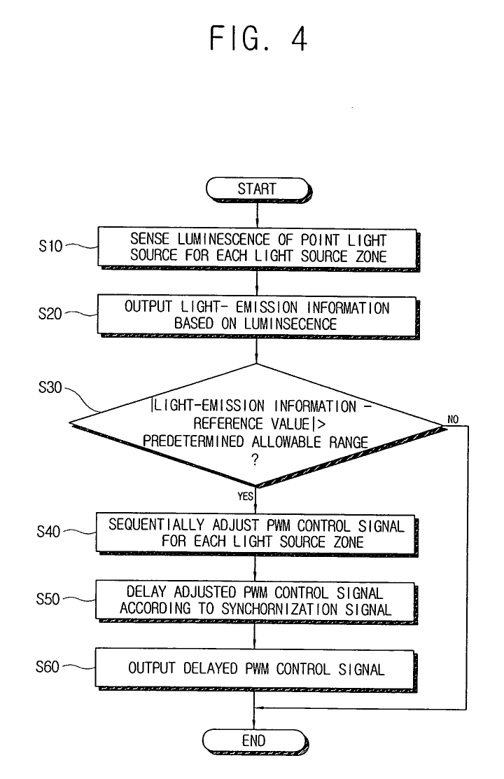

FIG. 4 is a control flow chart illustrating a control method of the display apparatus according to an exemplary embodiment of the present invention.

First, the plurality of sensors 311, 321, 331 and 341 sense the luminescence of the point light sources, that is, the light-emitting diodes 201, 202 and 203, for each of the light source zones 210, 220, 230 and 240 at operation S10. Based on the sensed luminescence, the light-emission information on the light-emitting diodes 201, 202 and 203 (the white color coordinates in this embodiment) is output at operation S20.

Then, at operation S30, the light-emission information, that is, the white color coordinates, is compared with a reference value corresponding to predetermined color temperature, and it is determined whether or not a difference between the light-emission information and the reference value is out of a predetermined allowable range.

If it is determined that the difference is out of the allowable range, PWM control signals are adjusted for each of the light source zones 210, 220, 230 and 240 and the adjusted PWM control signals are output in series at operation S40.

The PWM delay part 500 delays the adjusted PWM control signals according to a synchronization signal based on a driving system of the liquid crystal panel 100 at operation S50, and then outputs the delayed PWM control signals to the light source driving part 600 according to an image signal for forming each sub-frame at operation S60.

As is apparent from the foregoing description, exemplary embodiments of the present invention provide a display apparatus for easily processing light emission-related information sensed for each optical zone, and a control method thereof.

In addition, exemplary embodiments of the present invention provide a display apparatus with reduced production costs, and a control method thereof.

Although exemplary embodiments of the present invention have been shown and described, it will be appreciated by those skilled in the art that changes may be made in these embodiments in which light-emission information input from a plurality of channels is processed and output through one controller, without departing from the principles and spirit of the invention, the scope of which is defined in the appended claims and their equivalents.

What is claimed is:

1. A display apparatus having a liquid crystal panel, comprising:
a light source part comprising a plurality of point light sources for supplying light to the liquid crystal panel, the light source part being partitioned into a plurality of light source zones;
a light source driving part for supplying power to the light source part;
a plurality of channel parts for sensing luminescence of the point light sources for each of the light source zones and outputting light-emission information of the point light sources based on the sensed luminescence; and
a controller for comparing the light-emission information output from the plurality of channel parts with a pre-set reference value, and, sequentially adjusting PWM control signals if a difference between the light-emission information and the reference value is out of a predetermined allowable range, which control signals are output to the light source driving part, for each of the light source zones.

2. The display apparatus according to claim 1, wherein the light-emission information is white color coordinates of the point light-emitting sources.

3. The display apparatus according to claim 2, wherein each of the plurality of channel parts comprises:
a sensor for sensing luminescence of light emitted from the point light sources; and
a color coordinate calculator for calculating the white color coordinates of the point light sources based on the luminescence sensed by the sensor.

4. The display apparatus according to claim 1, further comprising a PWM delay part for delaying the PWM control signals output from the controller according to a predetermined synchronization signal.

5. The display apparatus according to claim 1, wherein the reference value is a color temperature value and/or a particular region on a gray axis.

6. A method of controlling a display apparatus comprising a liquid crystal panel, and a light source part comprising a plurality of point light sources for supplying light to the liquid crystal panel, the light source part being partitioned into a plurality of light source zones, the method comprising:
sensing luminescence of the point light sources for each of the light source zones;
outputting light-emission information of the light source zones based on the sensed luminescence;
comparing the output light-emission information with a pre-set reference value and sequentially adjusting PWM control signals if the difference between the output and the pre-set reference value is out of a predetermined allowable range, which control signals are output to the light source part, for each of the light source zones; and
delaying the PWM control signals according to a predetermined synchronization signal.

7. The method according to claim 6, wherein the light-emission information is white color coordinates of the point light-emitting sources.

8. The method according to claim 7, further comprising calculating the white color coordinates of the point light sources based on the sensed luminescence.

9. The method according to claim 6, wherein the reference value is a color temperature value and/or a particular region on a gray axis.

10. A computer readable medium of instructions for controlling a display apparatus comprising a liquid crystal panel and a light source part comprising a plurality of point light sources for supplying light to the liquid crystal panel, the light source part being partitioned into a plurality of light source zones, comprising:
a first set of instructions adapted to control the apparatus to sense luminescence of the point light sources for each of the light source zones;
a second set of instructions adapted to control the apparatus to output light-emission information of the light source zones based on the sensed luminescence;
a third set of instructions adapted to control the apparatus to compare the output light-emission information with a pre-set reference value and to sequentially adjust PWM control signals if the difference between the output and the pre-set reference value is out of a predetermined range; and
a fourth set of instructions adapted to control the apparatus to delay the PWM control signals according to a predetermined synchronization signal.

11. A display apparatus having a liquid crystal panel, comprising:
a light source part comprising a plurality of point light sources for supplying light to the liquid crystal panel, the light source part being partitioned into a plurality of light source zones;
a light source driving part for supplying power to the light source part; and
a controller for sequentially adjusting PWM control signals, which control signals are output to the light source driving part, for each of the light source zones.

12. The display apparatus according to claim 11, further comprising a plurality of channel parts for sensing luminescence of the point light sources for each of the light source zones and outputting light-emission information of the point light sources based on the sensed luminescence,
wherein the controller compares the light-emission information output from the plurality of channel parts with a pre-set reference value, and, adjusts PWM control signals if a difference between the light-emission information and the reference value is out of a predetermined allowable range.

13. The display apparatus according to claim 12, wherein each of the plurality of channel parts comprises:
a sensor for sensing luminescence of light emitted from the point light sources; and
a color coordinate calculator for calculating the white color coordinates of the point light sources based on the luminescence sensed by the sensor.

14. The display apparatus according to claim 11, further comprising a PWM delay part for delaying the PWM control signals output from the controller according to a predetermined synchronization signal.
